(19) United States
(12) Patent Application Publication
(10) Pub. No.: US 2014/0078460 A1
(43) Pub. Date: Mar. 20, 2014

(54) EYEGLASSES AND CLIPPING DEVICE THEREFOR

(71) Applicants: Jung-shih CHANG, Taichung City (TW); Tyler Scott STILSON, Frederick, CO (US)

(72) Inventors: Jung-shih CHANG, Taichung City (TW); Tyler Scott STILSON, Frederick, CO (US)

(21) Appl. No.: 13/687,414

(22) Filed: Nov. 28, 2012

(30) Foreign Application Priority Data
Sep. 18, 2012 (CN) 201210344491.2

(51) Int. Cl. G02C 7/08

(52) U.S. Cl. CPC G02C 7/08
USPC 351/57

(57) ABSTRACT

A clipping device is used to clip and hold one eyeglass frame or multi-eyeglass frames. The clipping device comprises a base, an upper portion and a lower portion. The base includes a top side, a bottom side, a front surface and a back surface. The base, the upper portion and the lower portion are constructed to jointly define a receiving room with multi-receiving sections to hold and clip one frame or multi-frames for eyeglasses.

### BACKGROUND OF THE INVENTION

1. Field of the Invention

The present invention relates to eyeglasses, more particularly, to a pair of eyeglasses including at least two frames which can be easily assembled with and disassembled from each other by a clipping device.

2. Description of the Related Art

U.S. Pat. No. 3,801,189 disclosed a frame of eyeglasses having a pair of lens-holding rings joined by a bridge split into two parts by a cut. The frame further includes a resilient removable clip fitted on the front of the bridge and engaging the upper and lower surfaces of the bridge so as to hold the two parts of the bridge together. The advantage of the resilient clip disclosed in the patent is that it enables the lenses of the eyeglasses to easily be changed or replaced. However, the resilient clip herein cannot engage a primary frame and a sealing member at the same time so that the eyeglasses assembled thereby can only be used in casual activities

U.S. Pat. No. 7,520,604 provides a pair of eyeglasses including an outer frame, an inner frame and a sealing member including a sponge portion attached to the inner surface of the inner frame, and a leather portion attached to an inner surface of the sponge portion. The outer frame has a lens holder for holding lenses and side assembling ribs protruding from the side edges of the lens holder, each of the side assembling ribs having a side assembling groove formed between the side assembling rib and the lens holder. The inner frame has side edges, each of which can be inserted in the side assembling groove so that the inner frame can be detachably assembled with the outer frame. As described above, such eyeglasses not only can be used in both sports and casual activities but include structures by which the outer frame and the inner frame can be easily assembled with and disassembled from each other. However, the eyeglasses still has some disadvantages, for example, the structure designed to assemble and disassemble the outer and inner frames thereof is not easy to be produced and the problem that the lenses are difficult to be inserted into or removed from the outer frame is not solved yet.

Accordingly, it needs to provide a new design which not only enables lenses of eyeglasses readily to be changed or replaced but also enables frames of a pair of multi-purpose eyeglasses to be easily assembled with and disassembled from each other.

### SUMMARY OF THE INVENTION

Thus, one objective of the present invention is to provide an improved clipping device for eyeglasses which can tightly hold and clip only one frame or multi-frames thereof.

Another objective of the present invention is to provide a combination including a clipping device and at least two frames which can be easily assembled with and disassemble from each other by the clipping device.

In order to accomplish these objectives, a clipping device according to one aspect of the present invention, which can tightly hold and clip only a primary frame or a primary frame and a secondary frame at the same time, comprises a base, an upper portion and a lower portion. The base includes a top side, a bottom side, a front surface and a back surface. The upper portion extends outwardly along a direction to which the front surface faces from the top side of the base. The lower portion also extends outwardly along the direction to which the front surface faces from the bottom side. The base, the upper portion and the lower portion are constructed in such a way that can jointly define a receiving room with multi-receiving sections to hold and clip only one frame or multi-frames at the same time.

A pair of eyeglasses according to another aspect of the present invention, which can be used in both sports and casual activities, comprise a primary frame, a secondary frame and a clipping device. The primary frame includes a pair of lens-holding rings, a bridge connecting the rings and being split into an upper part and a lower part by a cut. The secondary frame includes a body having a pair of lens-holding units, a nose piece connecting said units and a pair of ring-shaped pad secured respectively on an inner surface of each of the lens-holding units. The clipping device comprises a base, an upper portion and a lower portion. The base, the upper portion and the lower portion are constructed to form a C-shaped receiving room. The receiving room includes an upper side, a bottom side and an inner side disposed therebetween. The upper and bottom sides of the receiving room are both stepped to form a plurality of receiving sections with different height to hold and clip only the primary frame, or, when needs, the primary and secondary frames at the same time.

Other objects and features of the present invention will become apparent from the following detailed description, considered in conjunction with the accompanying drawings. It is to be understood, however, that the drawings are designed solely for the purpose of illustration and not as a definition of the limits of the invention, for which reference should be made to the appended claims.

### BRIEF DESCRIPTION OF THE DRAWINGS

FIG. 1 is a perspective view of a first pair of eyeglasses including a primary frame, a secondary frame with a sealing member, and a clipping device embodied according one aspect of the present invention;

FIG. 2 is a disassembled perspective view of the eyeglasses of FIG. 1;

FIG. 3 is a sectioned view of the clipping device of FIG. 1 taken along line 3-3 of FIG. 2;

FIG. 4 is a sectioned view of the eyeglasses of FIG. 1 taken along line 4-4 of FIG. 1;

FIG. 5 is a perspective view of a second pair of eyeglasses including a primary frame and a clipping device embodied according another aspect of the present invention; and

FIG. 6 is a sectioned view of the eyeglasses of FIG. 5 taken along line 6-6 of FIG. 5.

### DETAILED DESCRIPTION OF THE PREFERRED EMBODIMENTS

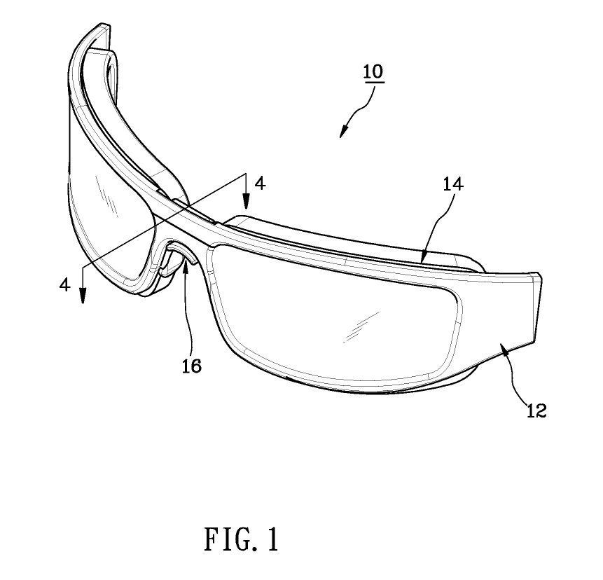

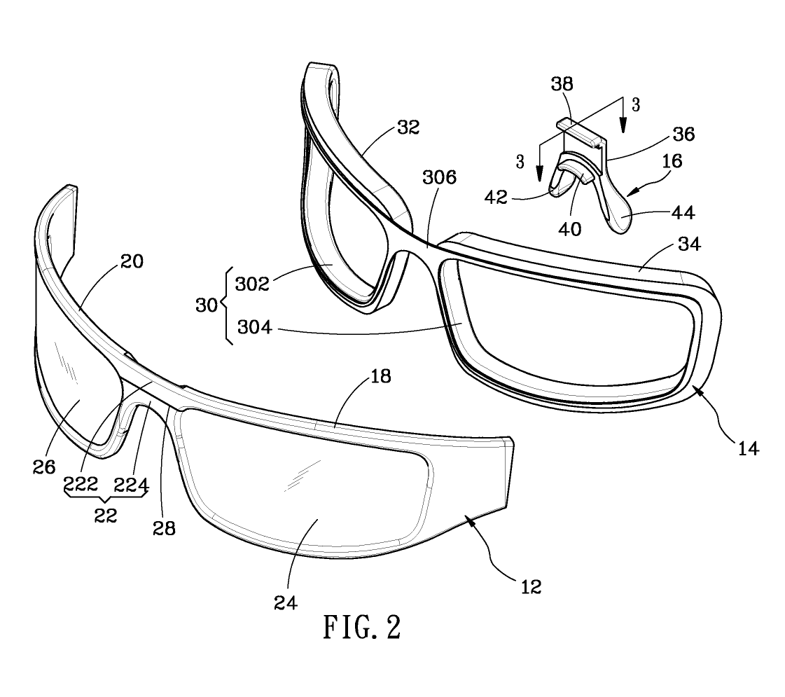

As shown in FIGS. 1-4, the drawings depict a first pair of eyeglasses 10 including a primary frame 12, a secondary frame 14 and a clipping device 16 embodied in accordance with one aspect of the present invention.

Primary frame 12, which is preferably made of plastic materials, light-weight metals or composited materials, includes a pair of lens-holding rings 18, 20 connected with each other at their medial sides by a bridge 22 that is adapted to extend across the wearer's nose. Lenses 24, 26 are conventionally installed into rings 18, 20. In this embodiment, bridge 22 is split into an upper part 222 and a lower part 224 by a cut 28 to enable these two rings 18, 20 to be simultaneously opened up by pulling in opposite directions so that lenses 24, 26 can be easily changed or replaced. A pair of temple bars or an adjustable elastic strap (not shown in the drawings) can be conventionally used to support primary frame 12 on the user's head.

Secondary frame 14, which is preferably constructed from the same material as primary frame 12, is detachably assembled inside of primary frame 12 having the construction described above. Therefore, a user can wear either only primary frame 12 or the assembled primary frame 12 and secondary frame 14 according to necessity.

Secondary frame 14 includes a body 30 having a pair of lens-holding units 302, 304 and a nose piece 306 connecting these units 302, 304. Frame 14 further includes a pair of ring-shaped ocular pads 32, 34, each of pads 32, 34 is respectively secured on the inner surface of each of lens-holding units 302, 304 of secondary frame 14.

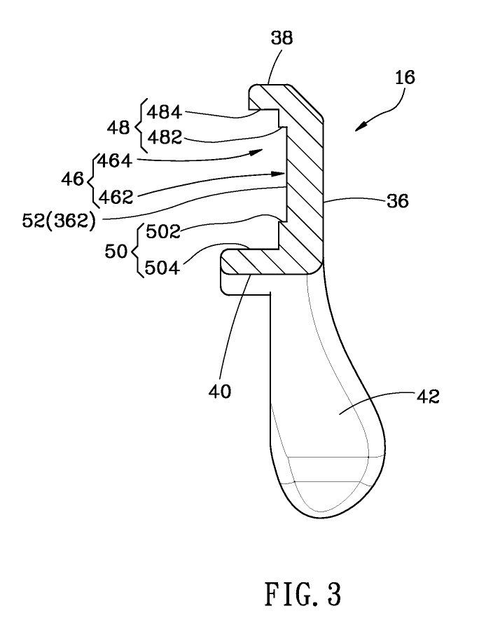

Clipping device 16, being made of materials having a substantially uniform modulus of elasticity, comprises a base 36, an upper portion 38, a lower portion 40 and a pair of nose pad 42, 44 extending downwardly from lower portion 40. As shown in FIG. 3, upper portion 38 extends outwardly from the top side of base 36 in a direction to which front surface 362 of base 36 faces. Lower portion 40 extends outward from the bottom side of base 36 in a direction being the same as the direction that upper portion 38 extends. Base 36, upper portion 38 and lower portion 40 jointly define a C-shaped receiving room 46 including an upper side 48, a bottom side 50 and an inner side 52. In the present embodiment, upper side 48 of receiving room 46 is stepped to form a first upper step 482 and a second upper step 484, bottom side 50 of receiving room 46 is also stepped to form a first bottom step 502 and a second bottom step 504 so that C-shaped receiving room 46 forms a first clipping section 462 and a second clipping section 464. First clipping section 462 is defined by first upper step 482, inner side 52 of receiving room 46, and first bottom step 502. Second clipping section 464 is defined by second upper step 484 and second bottom step 504. For contact with the wearer's nose, lower portion 40 is curved.

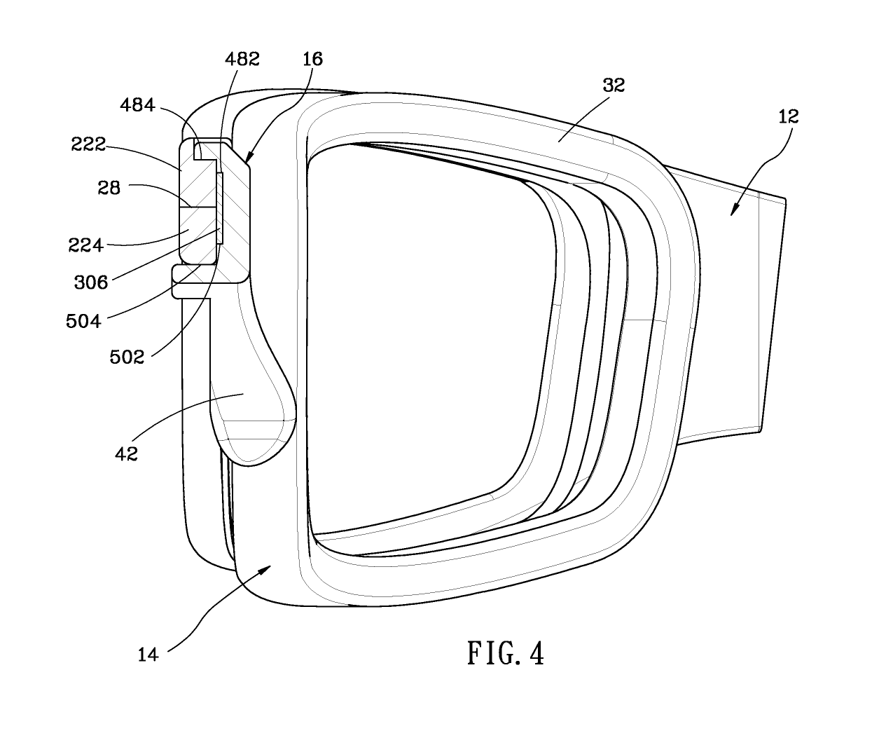

When eyeglasses 10 having the above-mentioned construction is assembled, as shown in FIGS. 1 and 4, nose piece 306 of body 30 of secondary frame 14 is firstly inserted into first clipping section 462 of receiving room 46 so that secondary frame 14 is tightly clipped and held by clipping device 16. And then, bridge 22 of primary frame 12 is pushed forward into second clipping section 464 of receiving room 46 so that primary frame 12 is also tightly clipped and held by clipping device 16 and at the same time upper part 222 and lower part 224 are urged toward each other. In this embodiment, for tightly assembling primary frame 12 and secondary frame 14 together. In this embodiment, Clipping device 16 is constructed in such a way that first receiving section 462 may have a size slightly smaller that of nose piece 306, and second receiving section 464 may have a size slightly smaller that of bridge 22. In addition, the distance between first upper step 482 and first bottom step 502 is smaller than that between second upper step 484 and second bottom step 504 so that said nose piece 306 of secondary frame 14 can be seated firmly in first clipping section 462.

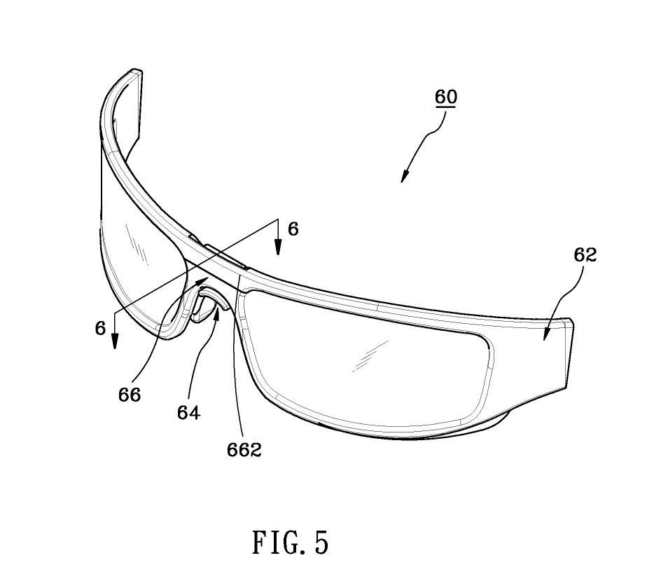

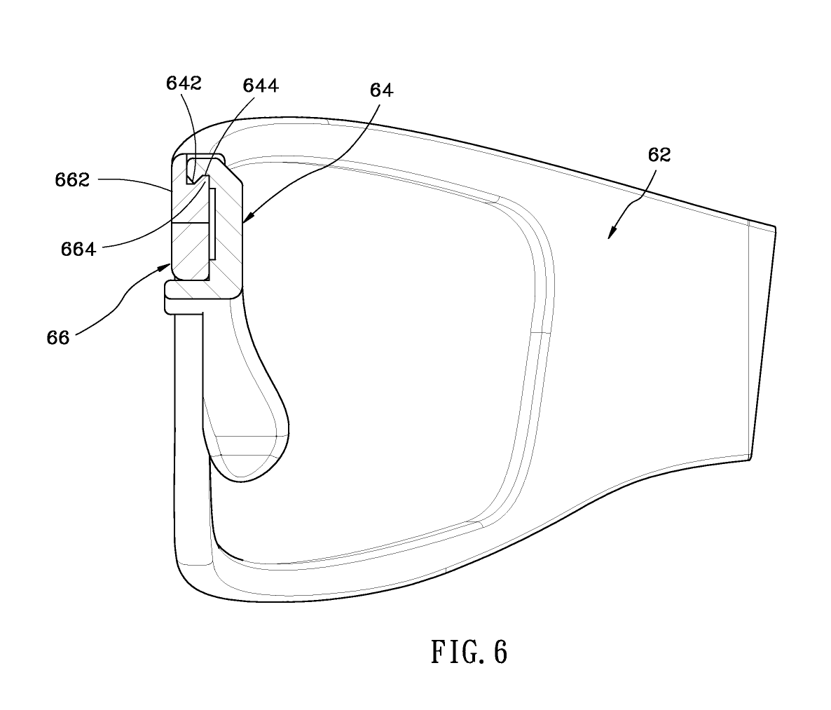

As shown in FIGS. 5 and 6, the drawings depict a second pair of eyeglasses 60 including only a primary frame 62 and a clipping device 64 embodied in accordance with another aspect of the present invention. Primary frame 62 and clipping device 64 are similar to primary frame 12 and clipping device 16 disclosed above. The difference between them is that second upper step 642 of clipping device 64 is configured to have a dent 644 to be wedged in by a rib 664 disposed on upper part 662 of bridge 66 of primary frame 62 so that primary frame 62 can be firmly clipped and held by clipping device 64 without having a secondary frame.

What is claimed is:

1. A clipping device for eyeglasses, comprising:
a base including a top side, a bottom side, a front surface and a back surface;
an upper portion extending outwardly along a direction to which said front surface of said base faces from said top side of said base;
a lower portion extending outwardly along the direction to which said front surface of said base faces from said bottom side; and
said base, said upper portion and said lower portion being constructed in such a way that can jointly define a receiving room with multi-receiving sections to hold and clip only one frame or multi-frames at the same time.

2. The clipping device of claim 1, wherein said receiving room includes an upper side, a bottom side and an inner side disposed therebetween.

3. The clipping device of claim 2, wherein said upper and bottom sides of said receiving room are both stepped to form a plurality of receiving sections with different height.

4. The clipping device of claim 1, wherein said receiving room is a C-shaped room with an upper side, a bottom side and an inner side disposed therebetween.

5. The clipping device of claim 4, wherein said upper top side of said receiving room is stepped to form a first upper step and a second upper step, said bottom side of said receiving room is also stepped to form a first bottom step opposed to said first upper step, and a second bottom step opposed to said second upper step so that said receiving room forms a first clipping section defined by said first upper step, said first bottom step and said inner side of said receiving room, a second clipping section defined by said second upper step and said second bottom step.

6. The clipping device of claim 5, wherein the distance between said first upper step and said first bottom step is smaller than that between said second upper step and said second bottom step.

7. The clipping device of claim 6, wherein said second upper step has a dent.

8. The clipping device of claim 1, wherein said lower portion is curved.

9. A combination, comprising:
a primary frame, a secondary frame and a clipping device;
said primary frame including:
a pair of lens-holding units;
a bridge connecting said units and being split into an upper part and a lower part by a cut;
said secondary frame including:
a body having a pair of lens-holding rings, a nose piece connecting said rings,
a pair of ring-shaped ocular pad secured respectively on an inner surface of each of said lens-holding rings;
said clipping device comprising:
a base including a top side, a bottom side, a front surface and a back surface;
an upper portion extending outwardly along a direction to which said front surface of said base faces from said top side of said base;
a lower portion extending outwardly along the direction to which said front surface of said base faces from said bottom side;
said base, said upper portion and said lower portion defining a receiving room including an upper side, a bottom side and an inner side; and
said upper side and bottom side both being stepped to form at least two clipping sections in said receiving room;
said bridge of said primary frame being clipped and held in one of said clipping sections; and
said nose piece of said secondary frame being clipped and held in the other of said clipping sections.

10. The combination of claim 9, wherein said upper side of said receiving room has a first upper step and a second upper step; said bottom side of said receiving room has a first bottom step opposed to said first upper step, a second bottom step opposed to said second upper step such that said first upper step, said first bottom step and said inner surface defines a first clipping section, said second upper step and said second bottom step defines a second clipping section.

11. The combination of claim 10, wherein the distance between said first upper step and said first bottom step is smaller than that between said second upper step and said second bottom step.

12. The combination of claim 11, wherein said second upper step has a dent.

13. The combination of claim 12, wherein said upper part of said bridge of primary frame has a rib to be wedged in said dent of said second upper step.

14. The combination of claim 9, wherein said lower portion of said base is curved.

15. A combination, comprising:
a frame and a clipping device;
said frame including:
a pair of lens-holding units;
a bridge connecting said units and being split into an upper part and a lower part by a cut;
said clipping device comprising:
a base including a top side, a bottom side, a front surface and a back surface;
an upper portion extending outwardly along a direction to which said front surface of said base faces from said top side of said base;
a lower portion extending outwardly along the direction to which said front surface of said base faces from said bottom side;
said base, said upper portion and said lower portion defining a receiving room including an upper side, a bottom side and an inner side; and
said upper side and bottom side both being stepped to form at least two clipping sections; and
said bridge of said frame being clipped and held in one of said clipping sections.

16. The combination of claim 15, wherein said upper side of said receiving room has a first upper step and a second upper step, said bottom side of said receiving room has a first bottom step opposed to said first upper step, a second bottom step opposed to said second upper step such that said first upper step, said first bottom step and said inner side defines a first clipping section, said second upper step and said second bottom step defines a second clipping section.

17. The combination of claim 16, wherein the distance between said first upper step and said first bottom step is smaller than that between said second upper step and said second bottom step.

18. The combination of claim 17, wherein said bridge of said frame is inserted into said second clipping section.

19. The combination of claim 17, wherein said second upper step has a dent.

20. The combination of claim 19, wherein said upper part of said bridge of said frame has a rib to be wedged in said dent of said second upper step.
